(19) United States
(12) Patent Application Publication
(10) Pub. No.: US 2016/0243523 A1
(43) Pub. Date: Aug. 25, 2016

(54) MAGNETIC NANOPARTICLES DECORATED ACTIVATED CARBON NANOCOMPOSITES FOR PURIFICATION OF WATER

(71) Applicant: COUNCIL OF SCIENTIFIC & INDUSTRIAL RESEARCH, New Delhi (IN)

(72) Inventors: Parveen SAINI, New Delhi (IN); Manju ARORA, New Delhi (IN); Ravinder Kumar KOTNALA, New Delhi (IN); Sunil Kumar BARALA, New Delhi (IN); Rajendra Prasad PANT, New Delhi (IN); Chandni PURI, New Delhi (IN)

(21) Appl. No.: 15/026,101

(22) PCT Filed: Sep. 30, 2014
(86) PCT No.: PCT/IN2014/000636

§ 371 Date: Mar. 30, 2016

(30) Foreign Application Priority Data
Sep. 30, 2013 (IN) 2891/DEL/2013

(51) Int. Cl. B01J 20/28; B01J 20/32; B01J 20/26; B01J 20/22; B01J 20/20; B01J 20/06

(52) U.S. Cl. CPC B01J 20/28009; B01J 20/20; B01J 20/06; B01J 20/262; B01J 20/22; B01J 20/3293; C02F 2101/308

(57) ABSTRACT

The present invention relates to the development of water purifying compositions based on magnetic nanoparticles decorated activated carbon nanocomposites which display both magnetic character as well as adsorbent characteristics. The addition of adsorbent to impure water containing dye as pollutant enables the fast adsorption of dye leading to discoloration of water whereas magnetic properties facilitates the rapid isolation of pollutant adsorbed nanocomposites powder from the purified water with the aid of a magnet. The present invention also provides a process for the development of such multifunctional adsorbent using a process which enables decoration of adsorbent with 5-50 weight % of magnetic nanoparticles, the enables the realization of magnetic adsorbent having saturation magnetization in the range 0.09 to 28.3 emu/g, dye removal efficiency of >99%, rapid decolourization of methylene blue (MB)/methyl orange (MO) dye polluted water in less than 1 min, magnetic separation time in the range <0.2 to 60 min and dye sorption capacity in the range of 3.3×10⁻⁴ to 116.3×10⁻⁴ mol of MB and 3.6×10⁻⁴ to 148.6×10⁻⁴ mol of MO dye per 100 gram of nanocomposite powder in a rapid adsorption (<1 min) and magnetic separation process. Besides, these nanocomposites could also be useful for other of applications e.g. as separation of catalytic residues from the products, for removal of oil from water, filler for development of thermally/electrically conducting magneto-rheological fluids or for handling of electromagnetic pollution.

### FIELD OF THE INVENTION

The present invention relates to magnetic nanoparticles decorated activated carbon nanocomposite as adsorbent for water purification. Particularly, present invention relates to the magnetic adsorbent where porous character enables the adsorption of pollutant whereas magnetic properties facilitates the rapid isolation of pollutant adsorbed nanocomposites powder from the purified water with the aid of a permanent magnet. More particularly, present invention also provides a method for the development of such multifunctional adsorbent using a process which enables decoration of adsorbent with up to 50 weight % of magnetic nanoparticles. These nanocomposites display direct applicability in separation of dyestuff from industrial effluent streams. However, they could also be used for a variety of applications such as isolation of catalytic impurities from the reaction products, for handling of oil spills, and for designing of thermally/electrically conducting magneto-rheological fluids.

### BACKGROUND OF THE INVENTION

Recent growth of paper, textile, leather, dyeing/printing and plastic industries and presence of dyes in their waste effluents is a major concern due to related environmental hazards. It is estimated that more than 100,000 commercially available dyes with over 7×10⁵ tonnes of dyestuff produced annually. The above industries cause discharge of dyes in the environment and generate a considerable amount of coloured wastewater. Many dyes are toxic/carcinogenic in nature and show resistant to degradation due to high stability towards light and oxidation. The presence of even very small amounts of dyes in water (few ppm for some dyes) is highly visible and undesirable e.g. exposure to basic dyes like methylene blue (MB, commonly used for dying of cotton, wood and silk) or methyl orange (MO, widely used in textile, printing, paper, food and pharmaceutical industries, research laboratories etc.) can cause eye burns, breathing difficulties, burning sensation, nausea, vomiting, profuse sweating, mental confusion and methemoglobinemia.

In the past, several methods have been adopted for the removal of dyes from wastewater e.g. photocatalytic degradation, sonochemical degradation, micellar enhanced ultrafiltration, cation exchange membranes, electrochemical degradation, adsorption/precipitation processes etc. Amongst the numerous techniques of dye removal, adsorption is the procedure of choice and gives the best results as it can be used to remove different types of colouring materials. Recently, numerous approaches have been studied for the development of cheaper and effective adsorbents. Among the proposed methods, removal of dyes by adsorption technologies is regarded as one of the competitive methods because of high efficiency, economic feasibility and simplicity of design/operation. Several adsorbents such as activated carbon, alginate bead, cellulose-based wastes, diaminoethane sporopollenin have been studied for the removal of both MO and MB dyes. Many non-conventional low-cost adsorbents, including natural materials, biosorbents, and waste materials from agriculture and industry, have been proposed. These materials could be used as adsorbents for the removal of dyes from solution

The activated carbons have been used as adsorbents for water purification as well as supports system for catalysis due to porous architecture. However, their separation from the system remained a problematic and tedious task e.g. it involves filtration or centrifugation steps which represent time consuming and non-scalable separation steps. Therefore, an effort has been made to develop water purifying adsorbing compositions based on magnetic nanoparticles decorated activated carbon with combination of magnetic properties and porosity. The porosity enables fast adsorption of pollutant molecules whereas magnetic character facilitates rapid magnetic separation of pollutant adsorbed particles of composite powder. The water purification capability has been demonstrated using common dyes such as methyl orange (MO), methylene blue, deliberately added to water as model impurities. The dye sorption capacity was found to be in the range of 3.3×10⁻⁴ to 116.3×10⁻⁴ mol of MB and 3.6×10⁻⁴ to 148.6×10⁻⁴ mol of MO dye per 100 gram of nanocomposite powder in a rapid adsorption (<1 min) and magnetic separation process.

The magnetic nanoparticles decorated porous carbon represent a class of multifunctional with excellent magnetic attributes along with micro-, meso- and macro-porosity that makes it important candidate for water purification. In particular, these multifunctional porous solids with additional magnetic functionality can provide an easy and scalable method for fast and large scale separation of activated carbons (with adsorbed impurity) without using the classical separation processes such as filtration or centrifugation, which represent time consuming and non-scalable separation techniques. In the present work, we adopted a facile and scalable approach to improve the magnetic properties of porous carbons by decoration with surface coated superparamagnetic nanoparticles. Besides, direct application in water purification, these multifunctional composites which may also be useful for enzymatic bioreactors, catalysis and electro/magneto rheological fluids, anti-radiation coatings etc. due to combination of electrical, magnetic and structural (porous morphology) attributes.

There are several patents and papers on the activated carbon based nanocomposites for water purification.

Patent PCT/ES2011/070145 [Aranda Ruiz-Hitzky, María-Pilar Gallego, Yorexis González-Alfaro, Method For Obtaining Materials With Superparamagnetic Properties, 2011, European Patent Application, EP 2 546 841 A1, International application number: PCT/ES2011/070145, WO 2011/110711] reported method for obtaining materials, comprising the treatment of solids by means of interaction with ferrofluids in order to provide the end product with superparamagnetic properties at moderate temperatures. These superparamagnetic materials are produced by assembling nanoparticles of metal oxides, which are associated with a compound having a surfactant effect, such as oleic acid, and which are carried by a non-aqueous ferrofluid, with a different type of solid material, preferably having adsorbent properties. In particular, active carbon (Norit® RO 0.8 pellets, supplied by Sigma-Aldrich)/oleic acid functionalized magnetite nanoparticles based nanocomposites (relative ratio of active carbon/magnetic nanoparticles of 50%) shows superparamagnetic character and ability to remove dye like methylene blue present in water. However, the specific absorption capacity was not given. The authors also mentioned that sepiolite/magnetite nanoparticles-oleic acid nanocomposites (50%) synthesized by them display the methylene blue sorption capacity of 0.213 mg/g of composite in 10 min and can be magnetically separated from the mother liquor.

US patent US 20110124492A1 [Loukine Nikolai, Anjan Das, Danielle Norton, Darren Anderson, Multifunctional Nanocomposites, US patent, 2011, US20110124492 A1] described methods of preparation of multifunctional nanocomposites magnetite comprising at least two components, at least one component of which is a nanoparticle comprising a polymer and the other component comprises an inorganic phase selected from the group consisting of amorphous carbon, pyrolytic carbon, activated carbon, charcoal, ash, graphite, fullerenes, nanotubes, diamond, metal oxides, mixed metal oxides, metal hydroxides, mixed metal hydroxides, metal oxyhydroxides, mixed metal oxyhydroxides, metal carbonates, tellurides salts, titanium dioxide, iron oxide, zirconium oxide, cerium oxide, magnesium oxide, silica, alumina, calcium oxide and aluminum oxide. The nanocomposites are porous with surface area greater than 100 m²/g. Nanomagnetic porous nanocomposites require conventional filtration and centrifugation techniques after the sorption of pollutant (e.g. M.B dye) was complete. It was also mentioned that magnetite sodium polyacrylate stabilized nanoparticle/activated carbon based nanocomposite has the properties of activated carbon, e.g. sorption of hydrophobic substances, and is magnetic which allows the separation of the nanocomposites from solution with an external magnet. However, the actual saturation magnetization and dye absorption capacity was not mentioned. US patent U.S. Pat. No. 4,201,831A [M. J. George Slusarczuk, Ronald E. Brooks, Magnetic adsorbent composite, US Patent, 1980, U.S. Pat. No. 4,201,831A] describes a method for making magnetic adsorbent composite composed of a magnetic substrate particle which is non-reactive under conditions of use and which is encapsulated with adherent activated carbon having a minimum surface area of about 200 square meters per gram and iodine number of at least about 50 with plurality of the nickel particles distributed in a matrix of elemental carbon as magnetic phase. A known weight adsorbent were weighed out into a 500 ml centrifuge bottle and loaded by shaking it with 250 ml of centrifuged septic effluent for 10 minutes. It was left to settle for another 10 minutes and the supernatant decanted. A small magnet was held below the stream during decantation, and it collected some fine sized magnetic adsorbent particles that would have been otherwise lost. The decanted supernatant was filtered and its TOD (Total Oxygen Demand) determined. The process was repeated three more times and was run in duplicate. On the average the magnetic adsorbent composite adsorbed about 200 milligrams TOD per gram of adsorbent.

Patent no. WO 2002069351 A1 [Saskia Duyvesteyn, D. Jan Millen, A. Gustavo Munozz, Magnetic activated carbon particles for adsorption of solutes from solution, PCT Patent, 2006, W02002069351A1] describes magnetic activated carbon particles for adsorption of solutes from solution. The carbon precursor of soft wood is soaked in a solution of a ferric salt, dried, pyrolyzed and activated. The very small particle size of the magnetic activated carbons (50 and 110 μm) results in higher adsorption kinetics than that of conventional granular activated carbon. The magnetic properties of the activated carbon permit gold-loaded activated carbon recovery from slurry by suitable magnetic separation method, such as a wet high intensity magnetic separator or magnetic drum separator, instead of the current screening process. Dry carbon, 0.100 g, was placed in 100 mL of a solution that contained 0.5 g/L NaCN and 10 mg/L Au at pH 11. The carbon gold-cyanide slurry was placed in a 150-mL plastic bottle, and shaken at 200 rpm for 2 hours. The solution was filtered and the gold content in solution was determined by inductively-coupled plasma emission spectroscopy (ICP)

Patent no. WO 2004064078A2 [W. David Mazyck, Magnetic activated carbon and the removal of contaminants from a fluid streams, PCT Patent, 2004, W02004064078A2] relates to magnetic activated carbon and the removal of contaminants from a fluid streams. The production of a 1:1 composite sample was done through the addition of 6 g of FeCl₃, 3 g of FeSO₄, and 9 g of activated carbon. The carbon and iron solutions are then mechanically mixed for at least 30 minutes. Afterwards, approximately 50 mL NaOH (ca. 5 mol/L) is added drop wise to increase the pH to approximately 10, which precipitated the iron oxides. Afterwards, the sample is oven dried at 105° C. for 12 hours to decrease the total moisture content to less than 3%. Bench-scale studies about the removal of mercury were performed in the apparatus which consisted of a small column reactor whereby high grade nitrogen gas from reservoir 100 was passed through an elemental mercury reservoir 110 to create a mercury vapor laden air with less than 45 ppb of Hg. They have not studied removal of methylene blue dye from the water.

Yorexis et al. [Yorexis Gonzalez-Alfaro, Pilar Aranda , Francisco M. Fernandes, Bernd Wicklein, Margarita Darder, and Eduardo Ruiz-Hitzky, Multifunctional Porous

Materials Through Ferrofluids, Adv. Mater. 2011, 23, 5224-5228] have prepared supported or dry ferrofluids, can show additional functionalities afforded by the solid support. This approach leads to the preservation of the characteristic adsorbent properties of pristine microporous solids, such as silica, clay minerals, zeolites or activated carbons. Interestingly, their superparamagnetic behaviour allows their controlled separation after the adsorbate uptake by application of an external magneticfield without loss of the immobilized nanoparticles (NPs). The authors reported that Norit® RO 0.8 active carbon pellets with attached oleic acid-magnetite NPs in a 1:1 ratio gives methylene blue (MB) dye adsorption capacity of ˜0.5 mol of MB per 100 g of solid (i.e. 1.6 g of M.B per gram of solid) which is three orders magnitude higher and even higher than literature value for pure Norit® RO 0.8 active carbon pellets (0.24 g MB per gram of Norit® RO solid pellet).

Hague et al. [Enamul Hague, Jong Won Jun, Sung Hwa Jhung, Adsorptive removal of methyl orange and methylene blue from aqueous solution with a metal-organic framework material, iron terephthalate (MOF-235), Journal of Hazardous Materials 185 (2011) 507-511] have prepared metal-organic frameworks (MOFs) system based on iron terephthalate (MOF-235) as a non-porous adsorbate for the removal of harmful dyes (anionic dye methyl orange (MO) and cationic dye methylene blue (MB)) from contaminated water with adsorption capacity of ˜460 and ˜160 mg/g of MOF-235 respectively. However, the magnetic properties of the system were not discussed. Further, the adsorption capacity of MOF-235 was compared and found to be much higher than those of an activated carbon (10-20 mg/g) at initial dye concentration (Ci) of 30 ppm. However, the compounds are non-magnetic therefore, cannot be separated by magnetic separation process and require time consuming filtration or centrifugation processes for separation of adsorbent from the purified water.

Rafatullah et al. [Mohd. Rafatullaha, Othman Sulaiman, Rokiah Hashim, Anees Ahmad, Adsorption of methylene blue on low-cost adsorbents: A review, Journal of Hazardous Materials 177 (2010) 70-80] has done exhaustive analysis of the removal of MB, as a pollutant, from waste waters of textile, paper, printing and other industries has been addressed by the researchers. The combination of biological treatment and adsorption on activated carbon become more common for removal of dyes from wastewater. Although commercial activated carbon is a preferred adsorbent for color removal, its widespread use is restricted due to its relatively high cost which led to the researches on alternative non-conventional and low-cost adsorbents.

Schwickardi et al. [Manfred Schwickardi, Stefan Olejnik, Elena-Lorena Salabas, Wolfgang Schmidt and Ferdi Schuth, Scalable synthesis of activated carbon with superparamagnetic properties, Chem. Commun., (2006) 3987-3989] studied the scalable synthesis of activated carbon with superparamagnetic properties. He studied the magnetic properties but water purification was not discussed.

Ozdemir et al. [C. Sarici-Ozdemir, Adsorption and desorption kinetics behaviour of methylene blue onto activated carbon, Physicochem. Probl. Miner. Process, 48 (2012) 441-454] investigated the potential use of activated carbon for the removal of Methylene Blue (MB) from wastewater MB solutions were prepared in distilled water at the desired concentrations. Adsorption experiments were carried out by agitating 0.1 g of WZ with 50 cm3 solutions of the desired concentration (50, 75 and 100 mg/dm³) at different values of time (1 to 60 min) and 25° C. in a thermostatic bath operating at 400 rpm. The adsorption capacity increased from 23.11 to 46.31 mg/g as the initial dye concentrations increased from 50 to 100 mg/dm³.

Rahman et al. [Mohammad Arifur Rahman, S. M. Ruhul Amin and A. M. Shafiqul Alam, Removal ofmMethylene Blue from Waste Water Using Activated Carbon Prepared from Rice Husk, Dhaka Univ. J. Sci. 60 (2012) 185-189] studied the adsorbent for the removal of methylene blue from aqueous solutions. The maximum uptakes of methylene blue by activated rice husk carbon at optimized conditions (particle sizes: 140 μm; Flow rate: 1.4 mL/min; pH: 10.0; initial volume of methylene blue: 50 mL and initial concentration of methylene blue: 4.0 mg/L etc.) were found to 97.15%. The results indicate that activated carbon of rice husk could be employed as low-cost alternatives to commercial activated carbon in waste water treatment for the removal of basic dyes.

Thakuria et al. [Thakuria, Pankaj; Joy, Pattayil Alias, Superparamagnetic Nanocomposite of Magnetite and Activated Carbon for Removal of Dyes from Waste Water, Nanoscience and Nanotechnology Letters, 1, 2009, 171-175] synthesized nanocomposite of superparamagnetic Fe₃O₄ and activated carbon (AC) at room temperature and characterized by various techniques. Magnetic measurements indicated that the Fe₃O₄ nanoparticles are isolated by the AC particles. The magnetic fluid obtained by dispersion of the nanocomposite in water is found to be relatively stable. The dispersion is found to be very efficient for the removal of methylene blue dye from water. Thus, the nanocomposite is highly suitable for removing dissolved dyes and other contaminants from waste water by a simple magnetic separation process after adsorption on AC.

Barala et al. [S. K. Barala, M. Arora, P. Saini, Magnetite decorated activated carbon composites for water purification, AIP Conf. Proc. 1536, 1244 (2013)] have prepared magnetite decorated activated carbon composites by admixing commercial grade kerosene ferrofluid with activated carbon in desired weight ratio followed by drying. The porosity and magnetic character provides adsorption and magnetic actuation properties to these composites so that saturation magnetization value of ˜25 emu/g and methylene blue (MB) adsorption capacity of only ˜4.4 mol of MB per gram of solid with dye removal efficiency of >98%. Further, the magnetic separation time was more than 5 min with possibility of recontamination with activated carbon particles that are devoid of magnetic nanoparticles.

Safarik et al. [Ivo Safarik, Konstanca Nymburska & Mirka Safarkova, Adsorption of Water-Soluble Organic Dyes on Magnetic Charcoal, J. Chem. Tech. Biotechnol. 0268-2575/97] studied the adsorption of water-soluble organic dyes on magnetic charcoal via entrapment of charcoal particles into the structure of magnetic iron oxides. Maximum adsorption capacities of water soluble organic dyes belonging to the triphenylmethane, heteropolycyclic and azodye groups ranged between 10 and 20 mg of dyes per 1 cm³ of the sedimented adsorbent; this corresponds to 132.5 to 265 mg of dyes per 1 g of the dried adsorbent after 30 minutes to 4 hr.

Sun et al. [H. Sun, L. Cao and L. Lu, Magnetite/Reduced Graphene Oxide Nanocomposites: One Step Solvothermal Synthesis and Use as a Novel Platform for Removal of Dye Pollutants, Nano Res. 2011, 4(6): 550-562] reported a simple one step solvothermal synthesis process for producing magnetite/reduced graphene oxide (MRGO) nanocomposites as an adsorbent for dye pollutants rhodamine B and malachite green. The adsorption of dyes with different concentrations (0.1 to 0.7 g/L) was studied at pH 7, with an adsorption time t=2 h, and temperature T=25° C. and found the correlation coefficient of rhodamine B and malachite green are 4.23 mg/g and 6.47 mg/g respectively. He has not studied the removal of methylene blue dye from water.

Oliveira et al. [Luiz C. A. Oliveira, Rachel. V. R. A. Rios, Jose D. Fabris, V. Gargc, Karim Sapag, Rochel M. Lago, Activated carbon/iron oxide magnetic composites for the adsorption of contaminants in water, Carbon 40 (2002) 2177-2183] have studied the adsorption features of activated carbon and the magnetic properties of iron oxides in a composite to produce magnetic adsorbents. These magnetic particles can be used as adsorbent for a wide range of contaminants in water and can subsequently be removed from the medium by a simple magnetic procedure. Activated carbon/iron oxide magnetic composites were prepared with weight ratios of 2:1, 1.5:1 and 1:1 and characterized by powder XRD, TG, magnetization measurements, chemical analyses, TPR, N adsorption-desorption isotherms, Mossbauer spectroscopy and SEM. N adsorption measurements showed that the presence of iron oxides did not significantly affect the surface area or the pore structure of the activated carbon. The adsorption isotherms of volatile organic compounds such as chloroform, phenol, chlorobenzene and drimaren red dye from aqueous solution onto the composites also showed that the presence of iron oxide did not affect the adsorption capacity of the activated carbon. They have also not studied the methylene blue dye.

In the present invention, we have prepared water purifying adsorbing compositions based on magnetic nanoparticles decorated activated carbon with magnetic properties along with porosity and the process for preparation for the same has been described. The porosity enables fast adsorption of pollutant molecules whereas magnetic character facilitates magnetic separation of pollutant adsorbed particles of composite powder. The water purification capability has been demonstrated using common dyes such as methyl orange (MO), methylene blue, deliberately added to water as model impurities and good purification response is observed in a rapid absorption and magnetic separation process. Due to their electrical, thermal and magnetic properties and porous nature, these composites may also be useful for enzymatic bioreactors, catalysis, EMI shielding materials and electro/magneto rheological fluids.

Yao et al. [Wei Yao a,b, Chen Shen a, Yun Lu, Fe₃O₄@C@polyaniline trilaminar core-shell composite microspheres as separable adsorbent for organic dye, Composites Science and Technology 87 (2013) 8-13] have prepared core-shell Fe₃O₄@C@polyaniline (PANi) composite microspheres via simple in situ polymerization in the absence of surfactants. The carbon intermediate layer plays an important role in the formation of trilaminar core-shell structure, as it protect the underlaying Fe₃O₄ particles from the corrosive HCI during in-situ polymerization. However, the coating plays being non-porous and consequently, impervious to acids, the carbon coating extend only weak contribution towards dye adsorption, with PANI being the main adsorbing component. These Fe₃O₄@C@PANI composite microspheres were used as magnetic adsorbent for the removal of methyl orange (MO) dye from aqueous solution. The maximum adsorption capability for MO dye was found to be 120.2 mg/g for complete equilibrium (long term test), though the adsorption capacity on the basis of 1 min additive mixing (short term test) was found to be less than 10 mg/g. Further, only 81% of the removal efficiency was retained after five adsorption-desorption cycles.

### OBJECTS OF THE INVENTION

Main objective of the present invention is to provide magnetic nanoparticles decorated activated carbon nanocomposite as adsorbent for water purification.

Another objective of the present invention is to provide nanocomposites based on magnetic nanoparticles decorated activated carbon with adsorptive removal of dyes from the waste industrial effluent streams followed by magnetic separation of the dye sorbed adsorbent.

Yet another objective of the present invention is to provide a method for the development of the magnetic nanoparticles decorated adsorbent based nanocomposites.

Yet another objective of the invention is to provide the superparamagnetic character to adsorbents by attachment of different magnetic nanoparticles in the pores of activated carbon.

Yet another objective of the invention is to preserve the porous nature of the adsorbent even after decoration with polymer-coated/surfactant-capped magnetic nanoparticles.

Yet another objective of the invention is to regulate the dye sorption capacity and magnetization by varying the magnetic particles content between (5-50 weight %).

Yet another objective of the present invention is to provide a process for the development of 5-50 weight % magnetic nanoparticles decorated adsorbents based nanocomposites wherein the composites with both porosity and magnetic character is fabricated by novel process (dispersed polymer-coated/surfactant-capped magnetic nanoparticles) thus enabling realization of magnetic adsorbent with preservation of superparamagnetic properties (of decorated nanoparticles) and adsorbent characteristics (of porous adsorbing substrate).

Yet another objective of the invention is to develop magnetic nanoparticles decorated porous adsorbents with rapid magnetic separation ability and high specific sorption capacity, enabling its use for (a) purification of dye polluted water, (b) for isolation of catalytic residues after completion of reaction and (c) possible use in suppression of electromagnetic noises.

### SUMMARY OF THE INVENTION

Accordingly, present invention provides a nanocomposite comprising capped magnetic nanoparticles and adsorbent in the weight ratio from 5:95 to 50:50 for use in adsorptive separation of dyestuffs from polluted water and magnetic separation of dye adsorbed adsorbent from the purified/decolorized water.

In an embodiment of the present invention, the adsorbent is selected from the group consisting of activated carbon, amorphous carbon, pyrolytic carbon, charcoal, peat, coal, ash, norit, exfoliated graphite, activated carbon fibers, carbon nanotubes, graphene, silica, clays, montmorillonite, bentonite, diatomite, perlite, glass wool, sepolite, silicates, and zeolites.

In another embodiment of the present invention, the capped magnetic nanoparticles are selected from polymer capped magnetic nanoparticles and surfactant capped magnetic nanoparticles.

In yet another embodiment of the present invention, the magnetic nanoparticles are selected from the group consisting of ferric oxide (γ-Fe₂O₃), ferrous-ferric oxide (Fe₃O₄), cobalt ferrite (CoFe₂O₄), Ni—Zn ferrite, and Mn—Ni—Zn ferrite.

In an embodiment of the present invention, the magnetic nanoparticle is Fe₃O₄

In still another embodiment of the present invention, the capping of the capped magnetic nanoparticles used is selected from polymer base capping and surfactant based capping.

In yet another embodiment of the present invention, the polymer used for capping magnetic nanoparticle is selected from the group consisting of polyaniline, polypyrrole, substituted analogues and combinations thereof.

In yet another embodiment of the present invention, the surfactant for capping nanoparticles is selected from the group consisting of oleic acid (OA), octadecyl amine

(ODA), Octadecylphosphonic acid (ODPA), Trioctylphosphine (TOP), Trioctylphosphonic oxide (TOPO), para toluene sulfonic acid (PTSA), cardanol azophenyl sulfonic acid (CDSA), dodecyl benzene sulfonic acid (DBSA), camphor sulfonic acid (CSA), Lignin sulfonic acid (LSA), and combinations thereof.

In yet another embodiment of the present invention, said nanocomposite exhibit saturation magnetization from 0.09 to 28.3 emu/g, dye removal efficiency >99%, rapid decolourization of methylene blue (MB)/methyl orange (MO) dye polluted water in less than 1 minute, magnetic separation time from 0.1 to 60 min and dye sorption capacity from 5.3×10⁻⁴ to 116.3×10⁻⁴ mol of MB and 4.9×10⁻⁴ to 148.6×10⁻⁴ mol of MO dye per 100 gram of nanocomposite powder in a rapid adsorption (<1 min) and magnetic separation process.

In yet another embodiment, the present invention provides a process for the preparation of nanocomposite comprising the steps of:
(i) adding 5 to 10% (w/v) adsorbent in a dispersion medium to obtain a dispersion;
(ii) dispersing 20 to 40% (w/v) decorated magnetic nanoparticles in a dispersion medium to obtain a dispersion;
(iii) mixing the dispersions as obtained in step (i) and (ii) to achieve 1:0.1 to 1:19 weight ratio of capped magnetic nanoparticles to adsorbent; and
(iv) shaking the contents of step (iii) for 5 to 30 minutes followed by drying at temperature from 50 to 60° C. for 30 to 40 min and at a temperature from 100 to 120° C. for 2 to 8 h to obtain the nanocomposites.

In yet another embodiment of the present invention, the dispersion medium is selected from the group consisting of toluene, benzene, acetone, chloroform, kerosene, dimethylsulfoxide (DMSO), dimethylformamide (DMF), N-methyl pyrrolidone (NMP), ethanol, and combinations thereof.

In yet another embodiment of the present invention, polymer coated magnetic nanoparticles decorated adsorbing nanocomposites exhibit the saturation magnetization in the range of 0.09-27.6 emu/g, dye removal efficiency of >99%, rapid decolourization of methylene blue (MB)/methyl orange (MO) dye polluted water in less than 1 minute, magnetic separation time in the range 1 to 60 min, dye removal capacity from 5.9×10⁻⁴ to 116.3×10⁻⁴ mol of MB and 6.5×10⁻⁴ to 148.6×10⁻⁴ mol of MO dye per 100 gram of nanocomposite powder in a rapid adsorption (<1 minute) and magnetic separation process.

In yet another embodiment of the present invention, surfactant capped magnetic nanoparticles decorated adsorbing nanocomposites exhibit the saturation magnetization in the range of 0.1-28.3 emu/g, dye removal efficiency of >99%, rapid decolourization of methylene blue (MB)/methyl orange (MO) dye polluted water in less than 1 min, magnetic separation time in the range <0.2 to 15 min, dye removal capacity in the range of 5.3×10⁻⁴ to 13.2×10⁻⁴ mol of MB and 4.9×10⁻⁴ to 12.8×10⁻⁴ mol of MO dye per 100 gram of nanocomposite powder in a rapid adsorption (<1 min) and magnetic separation process.

In yet another embodiment of the present invention, the nanocomposites may also be used for a variety of applications such as isolation of catalytic impurities from the reaction products, for handling of oil spills, and for designing of thermally/electrically conducting magneto-rheological fluids, suppression of electromagnetic radiations etc.

Still another embodiment of the present invention, dodecyl benzene sulfonic acid (DBSA) doped polyaniline is used as conducting polymer coating formed by chemical oxidative polymerization of aniline monomer.

### BRIEF DESCRIPTION OF ACCOMPANYING DRAWINGS

FIG. 1: SEM image of PF decorated AC nanocomposite (˜26 wt % Fe₃O₄) based adsorbent.

FIG. 2: SEM image of FF decorated AC nanocomposite (˜22 wt % Fe₃O₄) based adsorbent.

FIG. 3: VSM plot of the magnetic nanocomposites based on activated charcoal decorated with ˜42 wt % of PANI coated Fe₃O₄ nanoparticles.

FIG. 4: VSM plot of the magnetic nanocomposites based on activated charcoal decorated with ˜50 wt % of oleic acid capped Fe₃O₄ nanoparticles.

FIG. 5: UV-Visible spectra of aqueous MB solution after treatment with sequential incremental addition of nanocomposites (magnetic adsorbent) powder followed by magnetic separation.

FIG. 6: Demonstration of water purification using activated charcoal nanocomposite containing ˜22 wt % of oleic acid capped Fe₃O₄ nanoparticles.

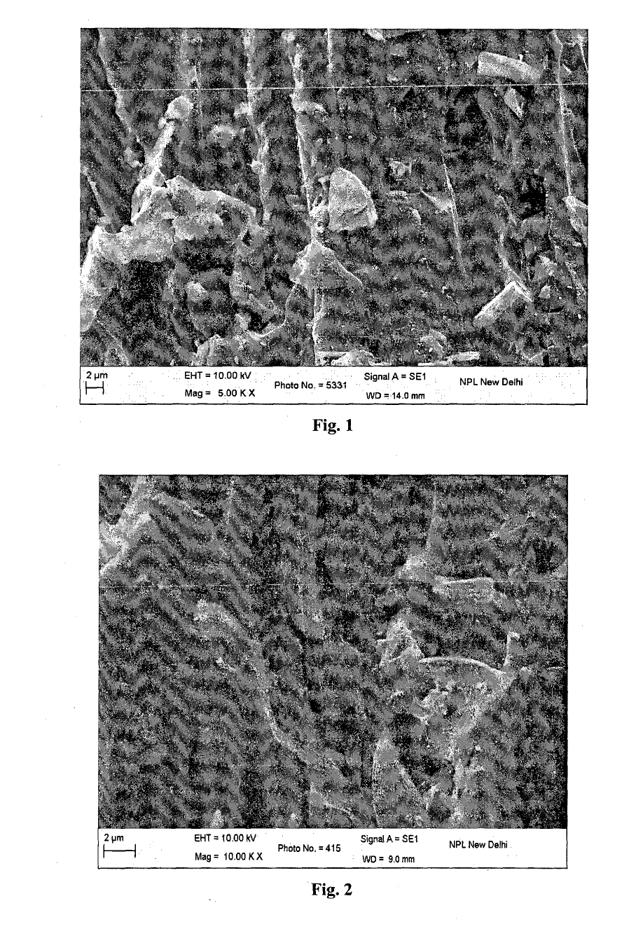

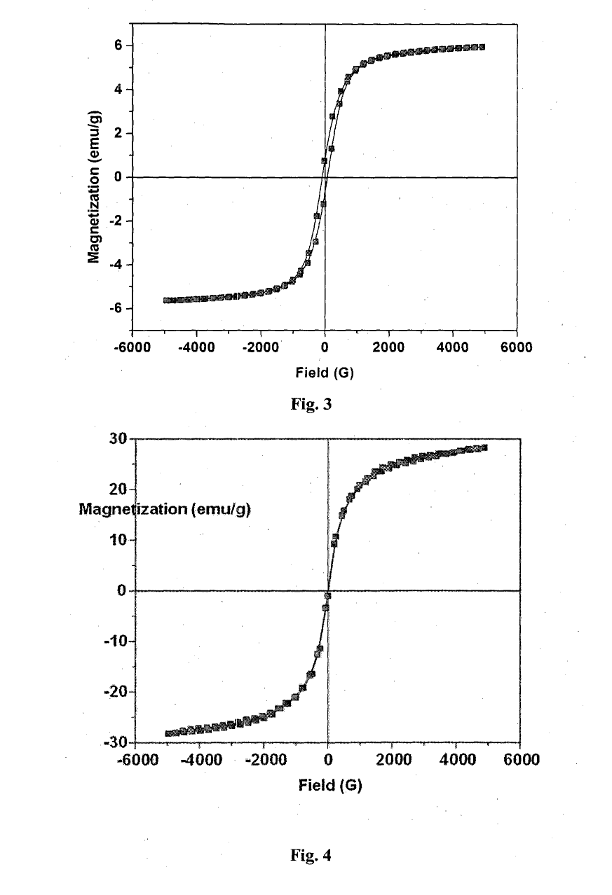

### DETAILED DESCRIPTION OF THE INVENTION

Present invention provides water purifying nanocomposites with 5 to 50 weight% loading of magnetic nanoparticles over adsorbent providing it magnetic character and preservation of adsorbent characteristics. These nanocomposites display saturation magnetization in the range of 0.01 to 32.2 emu/g, rapid decolourization of methylene blue (MB)/methyl orange (MO) dye polluted water in less than 1 min, dye removal efficiency of >99%, magnetic separation time in the range 0.1 to 60 min and dye sorption capacity in the range of 3.3×10⁻⁴ to 116.3×10⁻⁴ mol of MB and 3.6×10⁻⁴ to 148.6×10⁻⁴ mol of MO dye per 100 gram of nanocomposite powder in a rapid adsorption (<1 min) and magnetic separation process.

A magnetic adsorbent comprised of polymer-coated magnetic nanoparticles decorated activated carbon based nanocomposite having water purification capability prepared by a method involves the following steps. Magnetic nanoparticles [ferric oxide (γ-Fe₂O₃), ferrous-ferric oxide (Fe₃O₄), cobalt ferrite (CoFe₂O₄), Ni—Zn ferrite, Mn—Ni—Zn ferrite, preferably Fe₃O₄] of size (8-100 nm in diameter) are dispersed (using MICRA make high speed homogenizer rotating at ˜10,800 rpm) in a suitable aqueous emulsion of known concentration (preferably 0.3 M) of surfactants [para toluene sulfonic acid (PTSA), cardanol azophenyl sulfonic acid (CDSA) and dodecyl benzene sulfonic acid (DBSA), camphor sulfonic acid (CSA), Lignin sulfonic acid (LSA), preferably DBSA) with known weight ratio (2:1, 1:1, 1:2, and 1:3 preferably 1:3) of monomer (aniline, pyrrole and thiophene, preferably aniline) to Fe₃O₄, by homogenization of reaction mixture for known time (preferably 30 min). This leads to coating of surfactant over surface of nanoparticles which check their aggregation during reaction and forms a water based emulsion. Subsequently a known amount (preferably 0.1 M) of monomer was mixed with above emulsion and the system was homogenized for some more time (preferably 30 min). The mixture was transferred to a triple wall reactor, cooled to −2° C. and polymerized by dropwise addition of known concentration (preferably 0.1 M) of oxidant [ammonium peroxydisulfate (APS), potassium peroxydisulfate, ferric chloride, preferably APS] solution under continuous agitation. After completion of polymerization (6 h), the green colored dispersion of polymer (preferably PANI) coated Fe₃O₄ nanoparticles was formed that was demulsified using solvents (ethanol, iso-propanol, n-propanol, preferably iso-propanol), filtered and dried under vacuum. In next step, a known amount (20 to 40% w/v) of powdered PANI coated Fe₃O₄ nanoparticles (PF) were dispersed in solvent [toluene, benzene, acetone, chloroform, dimethylsulfoxide (DMSO), dimethylformamide (DMF), N-methyl pyrrolidone (NMP), ethanol, preferably chloroform] and mixed with separate dispersion of known amount (5 to 10% w/v) of adsorbent [preferably activated charcoal (AC) powder] in a solvent [toluene, benzene, acetone, chloroform, dimethylsulfoxide (DMSO), dimethylformamide (DMF), N-methyl pyrrolidone (NMP), ethanol, preferably chloroform] so that ratio of PF:AC was in the range 1:0.1 to 1:7.7 by weight. The contents were mechanically shaken for 5 min oven dried at 60° C. for 30 min followed by 120° C. for 2 h. The dried nanocomposites powder with known amount of Fe₃O₄ (5-50 weight %) display superparamagnetic characteristics saturation magnetization in the range of 0.09-27.6 emu/g, dye removal efficiency of >99%, rapid decolourization of methylene blue (MB)/methyl orange (MO) dye polluted water in less than 1 min.

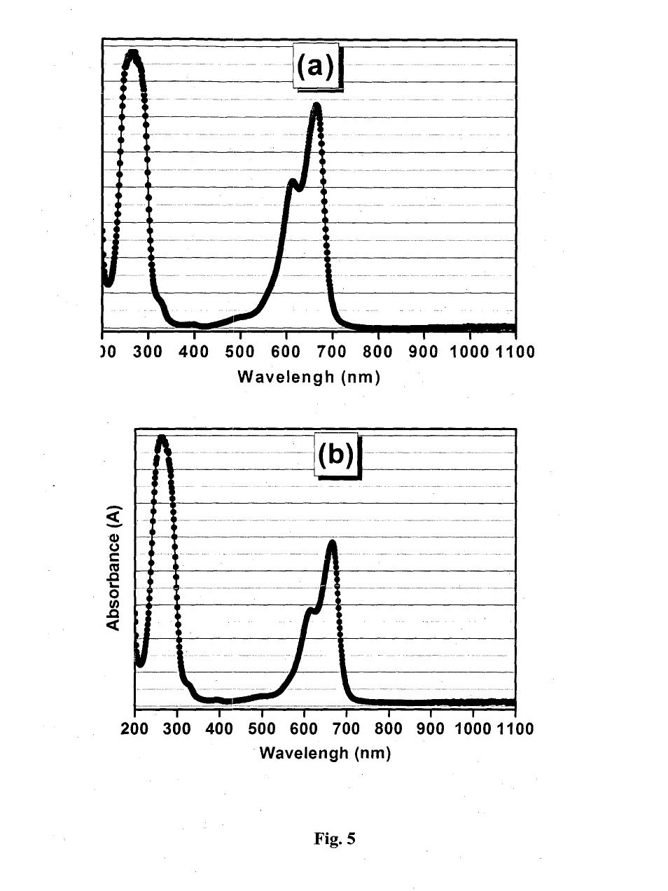

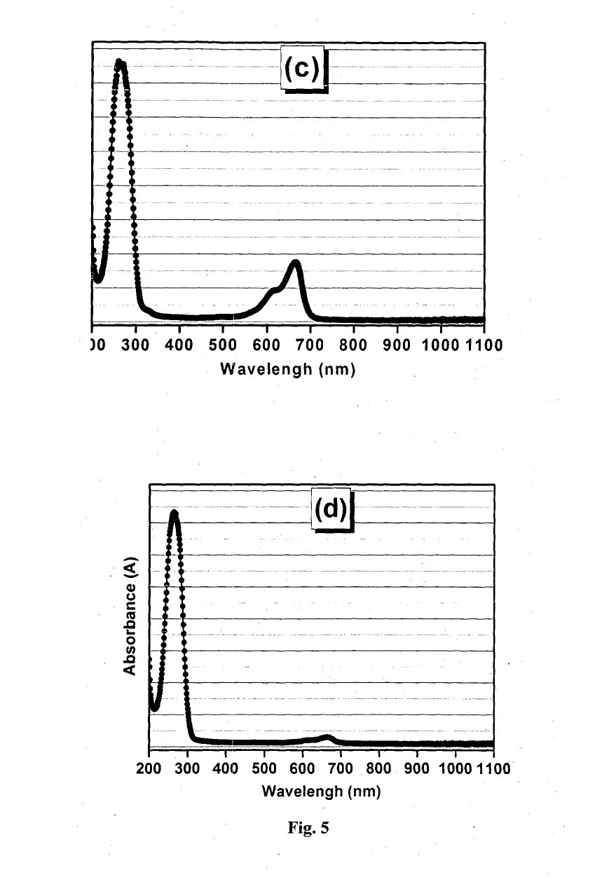

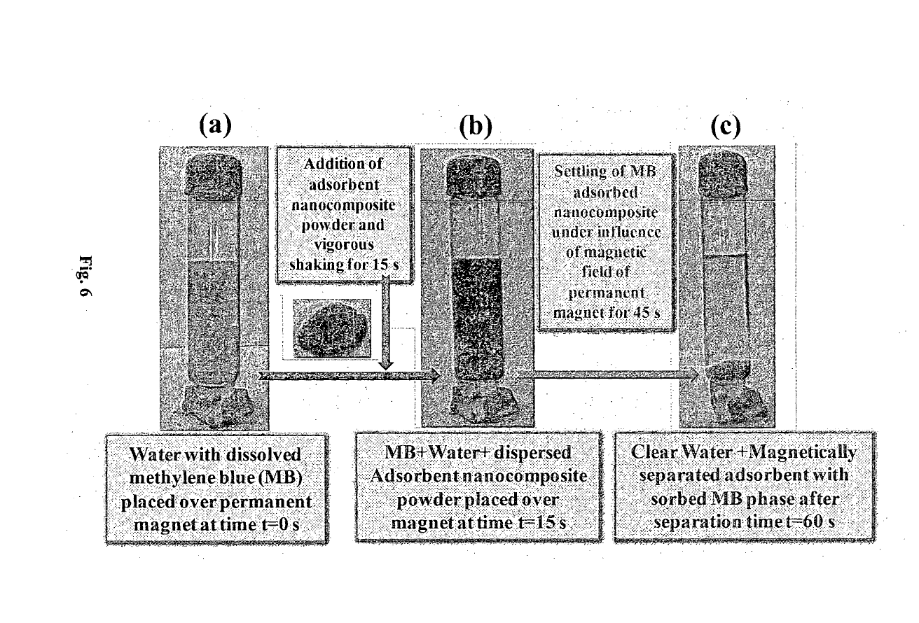

The nanocomposite (magnetic adsorbent) powder is tested for water purification capability by using water with deliberately added methylene blue (MB) or methyl orange (MO) dye (which gives intense coloration) as model impurity. For the quantitative measurement of dye sorption capacity, a known volume (10-20 ml in present work) of aqueous dye solution of known dye (MB or MO) concentration (10⁻⁴ Molar) was taken inside a glass culture bottle/reagent bottle. The UV-visible spectrum of the solution is collected e.g. Spectrum of MB (FIG. 5a) gives two characteristic peaks at 265 nm and 666 nm along with a shoulder at 615 nm. The intensity of shoulder as well as 666 nm peak is directly related to amount of MB in solution and can be used for quantitative measurements. A known amount of nanocomposites powder is added to the dye mixed aqueous solution, mechanically shaken for 30 s and dye adsorbed nanocomposites phase is magnetically separated from the solution. The solution becomes slightly less intense/light in color and its UV-visible spectrum is recorded again. It can be seen that as the above solution is mixed with increasing amount of nanocomposite powder, intensity of shoulder and last peak decreases (FIGS. 5b & 5c) in a systematic fashion. Finally, when enough nanocomposite powder was added to adsorb/absorb almost entire solution (making it visually transparent), the intensity of 666 nm peak becomes negligible (FIG. 5d) which gives a spectroscopic evidence of water purification capability. The amount of nanocomposite powder required gives the purification capacity of the material in terms of moles of MB per gram of nanocomposite powder. In similar fashion capacity for MO is also calculated. In order to verify the rapid adsorption and magnetic separation capability of various nanocomposites formulations, a predetermined amount of nanocomposites powder is added to the aqueous solution of dye (FIG. 6), mechanically shaken for few seconds and dye sorbed nanocomposites phase is allowed for magnetic separation by placing magnet under solution carrying bottle.

A magnetic adsorbent comprised of surfactant-capped magnetic nanoparticles decorated activated carbon based nanocomposite having water purification capability prepared by a method involves the following steps. Magnetic nanoparticles [ferric oxide (γ-Fe₂O₃), ferrous-ferric oxide (Fe₃O₄), cobalt ferrite (Co₃Fe₂O₄), preferably Fe₃O₄] of size (8-10 nm in diameter) prepared by chemical co-precipitation route. For synthesis of Fe₃O₄ nanoparticles, aqueous solutions of about 1.0 M FeCl_{2.}4H₂O and 2.0 M FeCl₃ were prepared and mixed under continuous agitation keeping the reaction temperature at 80° C. After 10 min, 5.0 ml of surfactant [oleic acid (OA), octadecyl amine (ODA), Octadecylphosphonic acid (ODPA), Trioctylphosphine (TOP), Trioctylphosphonic oxide (TOPO), PTSA, LSA, CSA, CDSA, DESA, preferably OA] was added and mixture was stirred for 30 min. Subsequently, the oleic acid capped Fe₃O₄ nanoparticles (FF) particles were formed by addition of ammonium hydroxide solution with continuous stirring for 3 h by maintaining the pH and temperature at 12 and 80° C. respectively leading to formation of brownish black Fe₃O₄ phase. The formed oleic acid capped particles were settled with the aid of permanent magnet and the supernatant liquid was decanted. The system was washed repeatedly with distilled water and the separated magnetic nanoparticles were dispersed in suitable carrier (kerosene in present case) to 50% solid content. In next step, about 40 ml of kerosene diluted oleic acid capped Fe₃O₄ (10 to 20% w/v of solid content) was mixed with separate dispersion of known amount (5 to 10% w/v) of adsorbent (preferably AC) in a solvent (preferably kerosene) so that ratio of PF:AC was in the range 1:1 to 1:19 by weight. The contents were mechanically shaken for 30 min followed by oven drying at 120° C. for 8 h. The dried nanocomposites powder with known amount of Fe₃O₄ (5-50 weight %) display superparamagnetic characteristics saturation magnetization in the range of 0.1-28.3 emu/g, dye removal efficiency of >99%, rapid decolourization of methylene blue (MB)/methyl orange (MO) dye polluted water in less than 1 min. The nanocomposite powder is tested for MB/MO dye adsorption and sorption capacity was calculated by method described earlier.

### EXAMPLES

The following examples are given by way of illustration and therefore should not be construed to limit the scope of the present invention.

### Example 1

Superparamagnetic porous adsorbent based on Polyaniline coated Fe₃O₄ nanoparticles decorated activated carbon (AC) was synthesized by chemical oxidative polymerization route. In a typical reaction, 0.1 M aniline monomer was mixed with aqueous emulsion of 0.3 M dodecyl benzene sulfonic acid (DBSA) with known amount (aniline:Fe₃O₄ ratio of 1:3) of predispersed Fe₃O₄ nanoparticles (procured from Sigma Aldrich, particle size <90 nm) and the system was homogenized for 30 min using high speed homogenizer (MICRA, ˜10,800 rpm). The mixture was transferred to a triple wall reactor, cooled to −2° C. and polymerized by dropwise addition of 0.1 M ammonium peroxydisulfate solution under continuous agitation. After completion of polymerization (6 h), the green colored dispersion of PANI coated Fe₃O₄ nanoparticles was formed that was demulsified using iso-propanol, filtered and dried under vacuum.

In next step, known amount of powdered PANI coated Fe₃O₄ nanoparticles (PF) were dispersed in 60 ml of chloroform and mixed with activated charcoal (AC) powder (Merck 17505, MB index of 180 mg/g) so that ratio of PF:AC was ˜1:7.7 by weight. The contents were mechanically shaken for 5 min oven dried at 60° C. for 30 min followed by 120° C. for 2 h. The dried nanocomposites powder with ˜6.5 wt % Fe₃O₄ display superparamagnetic characteristics with saturation magnetization value of 0.09 emu/g (Table 1), dye removal efficiency of >99% such that water with dissolved (10⁻⁴ M) MB and MO dyes becomes completely transparent within 1 min with sorption capacities of 116.3×10⁻⁴ mol of MB and 148.6×10⁻⁴ mol of MO per 100 gram of nanocomposite powder. The magnetic settling took about 60 min for the separation of dye sorbed nanocomposites powder from the decolorized water.

### Example 2

PF decorated AC nanocomposites (˜8.7 wt % Fe₃O₄) was prepared by wet mixing method in example 1 by taking PF:AC weight ratio of 1:5. The nanocomposites display magnetization value of 0.9 emu/g, magnetic settling time of 40-50 min and MB/MO dye sorption capacities as mentioned in the Table 1.

### Example 3

PF decorated AC nanocomposites (˜26 wt % Fe₃O₄) was prepared by wet mixing method in example 1 by taking PF:AC weight ratio of 1:1. The nanocomposites display magnetization value of 10.8 emu/g, magnetic settling time of 15 min and MB/MO dye sorption capacities as mentioned in the Table 1.

### Example 4

PF decorated AC nanocomposites (˜43 wt % Fe₃O₄) was prepared by wet mixing method in example 1 by taking PF:AC weight ratio of 1:0.2. The nanocomposites display magnetization value of 19.1 emu/g, magnetic settling time of 1 min and MB/MO dye sorption capacities as mentioned in the Table 1.

### Example 5

PF decorated AC nanocomposites (—47 wt % Fe₃O₄) was prepared by wet mixing method in example 1 by taking PF:AC weight ratio of 1:0.1. The nanocomposites display magnetization value of 27.6 emu/g, magnetic settling time of 1 min and MB/MO dye sorption capacities as mentioned in the Table 1.

### Example 6

A control PF sample without any AC was prepared by wet mixing method in example 1 by treating PF with chloroform followed by oven drying at 60° C. for 30 min and 120° C. for 2 h. The sample display properties mentioned in the Table 1.

### Example 7

Superparamagnetic porous adsorbent based on oleic acid capped Fe₃O₄ nanoparticles decorated activated carbon (AC) was synthesized by chemical co-precipitation route. In a typical reaction, 1.0 M FeCl_{2.}4H₂O and 2.0 M FeCl₃ aqueous solutions were prepared and mixed under continuous agitation keeping the reaction temperature at 80° C. After 10 min, 5.0 ml of oleic acid was added, mixture was stirred for 30 min. Subsequently, the oleic acid capped Fe₃O₄ nanoparticles particles were formed by addition of ammonium hydroxide solution with continuous stirring for 3h by maintaining the pH and temperature at 12 and 80° C. respectively leading to formation of brownish black Fe₃O₄ phase. The formed oleic acid capped particles were settled with the aid of permanent magnet and the supernatant liquid was decanted. The system was washed repeatedly with distilled water and the separated magnetic nanoparticles were dispersed in suitable carrier (kerosene in present case) to 50% solid content. The resultant stable dispersion was bark brown in color and shows formation of characteristic spike of ferrofluids in the presence of permanent magnet. The formation of Fe₃O₄ phase with size in the range of 9±1 nm was confirmed by X-ray diffraction (XRD) and high resolution transmission electron microscopy HR-TEM measurements on dried solids at 120° C.

In next step, about 40 ml of kerosene diluted oleic acid capped Fe₃O₄/kerosene ferrofluid was mixed with known amount of activated charcoal (AC) powder (Merck 17505, MB index of 180 mg/g) keeping ratio of dry ferrofluid (FF):AC as 1:19 by weight. The contents were mechanically shaken for 30 min followed by oven drying at 120° C. for 8 h. The dried nanocomposites powder with 5 wt % oleic acid capped Fe₃O₄ display superparamagnetic characteristics, saturation magnetization value of 0.1 emu/g, dye removal efficiency of >99% such that water with dissolved (1 M) MB and MO dyes becomes completely transparent within 1 min with sorption capacities of 13.2×10⁻⁴ mol of MB and 12.8×10⁻⁴ mol of MO per 100 gram of nanocomposite powder. The magnetic settling took about 15 min for the separation of dye sorbed nanocomposites powder from the decolorized water.

### Example 8

FF decorated AC nanocomposites (˜47 wt % Fe₃O₄) was prepared by wet mixing method as in example 7 by using about 40 ml of kerosene diluted ferrofluid and taking FF:AC weight ratio of 1:9.1. The nanocomposites display magnetization value of 1.7 emu/g, magnetic settling time of 5 min and MB/MO dye sorption capacities as mentioned in the Table 1.

### Example 9

FF decorated AC nanocomposites (˜22 wt % Fe₃O₄) was prepared by wet mixing method as in example 7 by using about 40 ml of kerosene diluted ferrofluid and taking FF:AC weight ratio of 1:3.5. The nanocomposites display magnetization value of 6.3 emu/g, magnetic settling time of 1 min and MB/MO dye sorption capacities as mentioned in the Table 1.

### Example 10

FF decorated AC nanocomposites (˜36 wt %' Fe₃O₄) was prepared by wet mixing method as in example 7 by using about 40 ml of kerosene diluted ferrofluid and taking FF:AC weight ratio of 1:1.8. The nanocomposites display magnetization value of 15.4 emu/g, magnetic settling time of 0.5 min and MB/MO dye sorption capacities as mentioned in the Table 1.

### Example 11

FF decorated AC nanocomposites (˜50 wt % Fe₃O₄) was prepared by wet mixing method as in example 7 by using about 40 ml of kerosene diluted ferrofluid and taking FF:AC weight ratio of 1:1. The nanocomposites display magnetization value of 28.3 emu/g, magnetic settling time of less than 0.2 min and MB/MO dye sorption capacities as mentioned in the Table 1.

### Example 12

A control activated charcoal sample was also prepared and about 40 ml of pure kerosene was mixed with 10 g of activated charcoal powder and contents were mechanically shaken for 30 min and oven dried at 120° C. for 8 h. The dried powder display nonmagnetic characteristics with extremely low saturation magnetization value of 0.01 emu/g, dye removal efficiency of >99%, lack of magnetic separation capability (need centrifugation/filtration) and MB/MO dye sorption capacity values as per data given in Table 1.

### Example 13

The wet nanocomposite particles with sorbed MB phase and magnetically separated in examples 7-11 were subjected to reactivation by heating in a vacuum over at 125° C. for 12 h and used for purification again. It was observed that after 5 cycles of adsorption, separation and purification, the dried powder still showed superparamagnetic response with less than 5% loss in magnetization, dye removal efficiency of >98%, less than 5% loss in MB/MO dye adsorption capacity.

TABLE 1
Saturation magnetization, dye sorption capacity and magnetic separation time
for Fe₃O₄ nanoparticles decorated AC based nanocomposites

| | | | Sorption capacity for | | |
|---|---|---|---|---|---|
| | | Saturation | decolourization of dye | | Magnetic |
| | | magnetization | within 1-min (milli-mol/kg) | | separation |
| S. No. | Sample | (emu/g) | MB | MO | time (min) |
| 1. | Pure AC | 0.01 | 36.4 | 33.3 | Not possible |
| 2. | FF:AC = 1:19 | 0.1 | 13.2 | 12.8 | 15 |
| 3. | FF:AC = 1:14.3 | 0.5 | 12.3 | 11.9 | 10 |
| 4. | FF:AC = 1:9.1 | 1.7 | 11.4 | 11.1 | 5 |
| 5. | FF:AC = 1:5.7 | 2.4 | 10.9 | 10.6 | 2 |
| 6. | FF:AC = 1:3.5 | 6.3 | 9.3 | 9.1 | 1 |
| 7. | FF:AC = 1:1.8 | 15.4 | 8.5 | 8.3 | 0.5 |
| 8. | FF:AC = 1:1.3 | 20.7 | 7.1 | 6.8 | 0.3 |
| 9. | FF:AC = 1:1 | 28.3 | 5.3 | 4.9 | <0.2 |
| 10. | Pure PF | 32.2 | 3.3 | 3.6 | 0.5 |
| 11. | PF:AC = 1:0.1 | 27.6 | 5.9 | 6.5 | 1 |
| 12. | PF:AC = 1:0.2 | 19.1 | 8.5 | 8.9 | 3 |
| 13. | PF:AC = 1:0.6 | 13.4 | 17.6 | 18.3 | 5 |
| 14. | PF:AC = 1:1 | 10.8 | 29.7 | 33.3 | 15 |
| 15. | PF:AC = 1:1.4 | 5.9 | 36.5 | 42.1 | 20-25 |
| 16. | PF:AC = 1:3 | 2.1 | 53.8 | 59.8 | 30-40 |
| 17. | PF:AC = 1:5 | 0.2 | 69.2 | 75.1 | 40-50 |
| 18. | PF:AC = 1:7.7 | 0.09 | 116.3 | 148.6 | 60 |

### ADVANTAGES OF THE INVENTION

The main advantages of the present invention are
1. It gives a facile and scalable approach for making magnetic adsorbents via which a gallery of magnetic nanoparticles can be easily decorated/coated within the porous network present inside the adsorbent particles with preservation of their superparamagnetic character.
2. The magnetic nanoparticles (5 to 50 wt %) can be easily decorated over walls of pores by carefully controlling the concentration/nature of magnetic nanoparticles in carrier fluid as well as adsorbent to nanoparticle loaded fluid ratio, which in turn can provide the magnetic character to adsorbent.
3. These magnetic nanoparticle decorated activated carbon based adsorbents facilitate fast and easy magnetic separation of pollutant sorbed magnetic nanocomposites powder from aqueous phase leaving behind pure/decolorized water.
4. The porosity enables fast adsorption of pollutant molecules whereas magnetic character facilitates rapid magnetic separation of pollutant adsorbed particles of composite powder. The maximum water purification capability has been found to be upto 116.3×10⁻⁴ mol and 148.6×10⁻⁴ mol of MB and MO dye respectively per 100 gram of nanocomposite powder in a rapid (<60 sec) absorption and magnetic separation process, though the capacity in long-time regime (i.e. after equilibrium is reached at maximum capacity) was about orders magnitude higher (˜1213 mg/g).
5. These nanocomposites can provide an efficient (fast and scalable) solution for purification/treatment of waste water especially removal of hazardous dyes from industrial effluent streams.
6. In addition, these nanocomposites may also be useful for removal of oils (kerosene/diesel/petrol) from water, for bioenzymatic reactors, separation of catalyst residues from the reaction mixture, for synthesis of electro or magneto rheological fluids and for anti-radiation coatings.
7. The method is simple yet scalable and involves only few processing steps.

1. (canceled)

2. (canceled)

3. (canceled)

4. (canceled)

5. (canceled)

6. (canceled)

7. (canceled)

8. (canceled)

9. A process for the preparation of a nanocomposite comprising polymer based capped magnetic nanoparticles and adsorbent in a weight ratio from 5:95 to 50:50, comprising the steps of:
(i) adding 5 to 10% (w/v) adsorbent in a dispersion medium to obtain a dispersion;
(ii) capping magnetic nanoparticles with a polymer to obtain capped magnetic nanoparticles;
(iii) dispersing 20 to 40% (w/v) capped magnetic nanoparticles in a dispersion medium to obtain a dispersion;
(iv) mixing the dispersions as obtained in step (i) and (iii) to achieve 1:0.1 to 1:19 weight ratio of capped magnetic nanoparticle to adsorbent; and
(v) shaking the contents of step (iv) for 5 to 30 minutes followed by drying at temperature from 50 to 60° C. for 30 to 40 min and at temperature from 100 to 120° C. for 2 to 8 h to obtain the nanocomposites.

10. The process as claimed in claim 9, wherein the dispersion medium is selected from the group consisting of toluene, benzene, acetone, chloroform, kerosene, dimethylsulfoxide (DMSO), dimethylformamide (DMF), N-methyl pyrrolidone (NMP), ethanol, and combinations thereof.

11. A nanocomposite prepared by the process as claimed in claim 9, wherein the weight ratio of capped magnetic nanoparticles and adsorbent in said nanocomposite is from 5:95 to 50:50, and the capping of said capped magnetic nanoparticles is polymer based capping.

12. The nanocomposite as claimed in claim 11, wherein the adsorbent is selected from the group consisting of activated carbon, amorphous carbon, pyrolytic carbon, charcoal, peat, coal, ash, norit, exfoliated graphite, activated carbon fibers, carbon nanotubes, graphene, silica, clays, montmorillonite, bentonite, diatomite, perlite, glass wool, sepolite, silicates, and zeolites.

13. The nanocomposite as claimed in claim 11, wherein the magnetic nanoparticles are selected from the group consisting of ferric oxide (γ-Fe₂O₃), ferrous-ferric oxide (Fe₃O₄), cobalt ferrite (CoFe₂O₄), Ni—Zn ferrite, and Mn—Ni—Zn ferrite.

14. The nanocomposite as claimed in claim 13, wherein the magnetic nanoparticle is Fe₃O₄.

15. The nanocomposite as claimed in claim 11, wherein the polymer for capping the magnetic nanoparticle is selected from the group consisting of polyaniline, polypyrrole, substituted analogues, and combinations thereof.

16. The nanocomposite as claimed in claim 11, wherein said nanocomposite exhibits saturation magnetization from 0.09 to 28.3 Am²/kg, dye removal efficiency >99%, rapid decolourization of methylene blue (MB)/methyl orange (MO) dye polluted water in less than 1 minute, magnetic separation time from 0.1 to 60 min and dye sorption capacity from 5.3×10⁻⁴ to 116.3×10⁻⁴ mol of MB and 4.9×10⁻⁴ to 148.6×10⁻⁴ mol of MO dye per 100 gram of nanocomposite powder in a rapid adsorption (<1 min) and magnetic separation process.

17. Use of the nanocomposite as claimed in claim 11 in adsorptive separation of dyestuffs from polluted water and magnetic separation of dye adsorbed adsorbent from purified/decolorized water.
